(19) United States
(12) Patent Application Publication
(10) Pub. No.: US 2018/0242531 A1
(43) Pub. Date: Aug. 30, 2018

(54) DEVICE FOR PROMOTING ROOT FUNCTION IN INDUSTRIAL FARMING

(71) Applicant: Kiwis LLC, Boulder, CO (US)

(72) Inventors: Henry Kistler BERRY, III, Boulder, CO (US); Henry Kistler BERRY, JR., Boynton Beach, FL (US)

(21) Appl. No.: 15/913,769

(22) Filed: Mar. 6, 2018

Related U.S. Application Data
(60) Provisional application No. 62/588,089, filed on Nov. 17, 2017.
(60) Provisional application No. 62/455,673, filed on Feb. 7, 2017.
(60) Provisional application No. 62/450,920, filed on Jan. 26, 2017.
(60) Provisional application No. 62/498,746, filed on Jan. 6, 2017.

(51) Int. Cl. A01G 7/06; A01G 9/02; A01G 9/24; A01G 27/00; A01G 22/05; A01G 17/02; A01G 22/60

(52) U.S. Cl. CPC A01G 7/06; A01G 9/02; A01G 9/245; A01G 22/60; A01G 22/05; A01G 17/02; A01G 27/005

(57) ABSTRACT

A device for promoting root function of a plant may include a first container configured to retain a root growing medium; a second container below the first container, wherein the second container is configured to store a liquid; an insulated enclosure surrounding the first container and the second container and including an opening above the first container that is sized so that the plant may grow through the opening; a pump configured to transport the liquid from the second container to the first container; a heater within the insulated enclosure; and a flow path from the first container to the second container that allows the liquid to flow from the first container to the second container after the liquid is transported to the first container.

This application claims priority to provisional application Nos. 62/588,089 filed Nov. 17, 2017; 62/455,673 filed Feb. 7, 2017; 62/450,920 filed Jan. 26, 2017; and 62/498,746 filed Jan. 6, 2017, each of which is incorporated by reference in its entirety.

### BACKGROUND

Certain plant species may have ideal or preferable conditions for the root structure that differ from the stems and leaves (hereinafter collectively referred to as vegetation). For example, the temperature or moisture content that is preferred for root function may not be ideal for vegetation growth, function or development. If roots prefer high moisture conditions, exposing the vegetation to the same moisture conditions may cause an infestations of bacteria, fungus, mold or mildew to grow on the vegetation. Certain conditions may also promote an insect infestation of the roots or vegetation. In an industrial farming operation, an infestation may require the plant to be destroyed because the infestation may render the plant no longer suitable as a crop.

Industrial farming may take place in an environment, such as a greenhouse, where a plurality of plants are in a common area. If one plant is infested, there is a risk that all plants are infested. Thus an infestation of a single plant may require destruction of all plants within the greenhouse.

### BRIEF SUMMARY

By providing separate environmental controls for the root structure, a plant may exhibit superior crop characteristics compared to environmental conditions where the root structure and vegetation are not controlled separately. Superior crop characteristics may include improved root function, faster growth, greater maximum growth, greater yield per plant, greater yield per area of space, improved resistant to infestation, etc.

Any plants may benefit from separate environmental control of the root structure. Exemplary plants may include fruit trees (e.g., citrus trees), avocado trees, flowers, grape vines, tomatoes, peppers, cannabis, etc.

An example of the present technology is an enclosure for the root system of a plant that provides controllable environmental conditions for the root structure. Such controllable environmental conditions may include temperature and/or moisture control.

Another example of the present technology is a device for promoting root function of a plant in industrial farming. The device includes a first container configured to retain a root growing medium; an insulated enclosure surrounding the first container and including an opening above the first container through which the plant may grow, wherein the opening is smaller than a maximum horizontal width of the first container; a wool collar within the opening and sized to surround the plant at the opening; a second container below the first container and within the insulated enclosure, wherein the second container is configured to store a liquid; a pump and at least one conduit configured to transport the liquid from the second container to the first container; a heater within the insulated enclosure; and a flow path from the first container to the second container that allows the liquid to flow from the first container to the second container by way of gravity. The insulated enclosure includes insulation configured to maintain the root growing medium between 65 and 75 degrees Fahrenheit while the exterior of the insulated enclosure is exposed to temperatures between 85 and 90 degrees Fahrenheit for 18 hours followed by exposure to 32 degrees Fahrenheit for 6 hours.

Another example of the present technology is a device for promoting root function of a plant. The device includes a first container configured to retain a root growing medium; a second container below the first container, wherein the second container is configured to store a liquid; an insulated enclosure surrounding the first container and the second container and including an opening above the first container that is sized so that the plant may grow through the opening; a pump configured to transport the liquid from the second container to the first container; a heater within the insulated enclosure; and a flow path from the first container to the second container that allows the liquid to flow from the first container to the second container after the liquid is transported to the first container.

With examples of the present technology, the environmental conditions of the root structure and/or the root growing medium, may be controlled. For example, the temperature and moisture content can be controlled separately from the vegetation. This may allow for improved growth of the plant or improved resistance of the plant to infestation compared to conditions where the root structure and vegetation do not have separately controlled environmental conditions. In a greenhouse (or other growth environment), the overall ambient conditions may be controlled for preferred vegetation conditions while the present technology is employed to provide preferred or improved conditions for the root structure.

### BRIEF DESCRIPTION OF THE DRAWINGS

FIG. 1 is an environmental view illustrating a cross-section of an example of the present technology with a plant;

FIG. 2 is a perspective view illustrating an example of the present technology;

FIG. 3 is a cross-section of the example illustrated in FIG. 2;

FIG. 4 is a cross-section of the example illustrated in FIG. 2 illustrating additional interior features;

FIG. 5 is a perspective view illustrating an exterior structure in an example of the present technology;

FIG. 6 is a perspective view illustrating of an exemplary container according to the present technology;

FIG. 7 is a perspective view illustrating an exemplary container according to the present technology; and

FIG. 8 is schematic illustrating certain control aspects according to the present technology.

### DETAILED DESCRIPTION

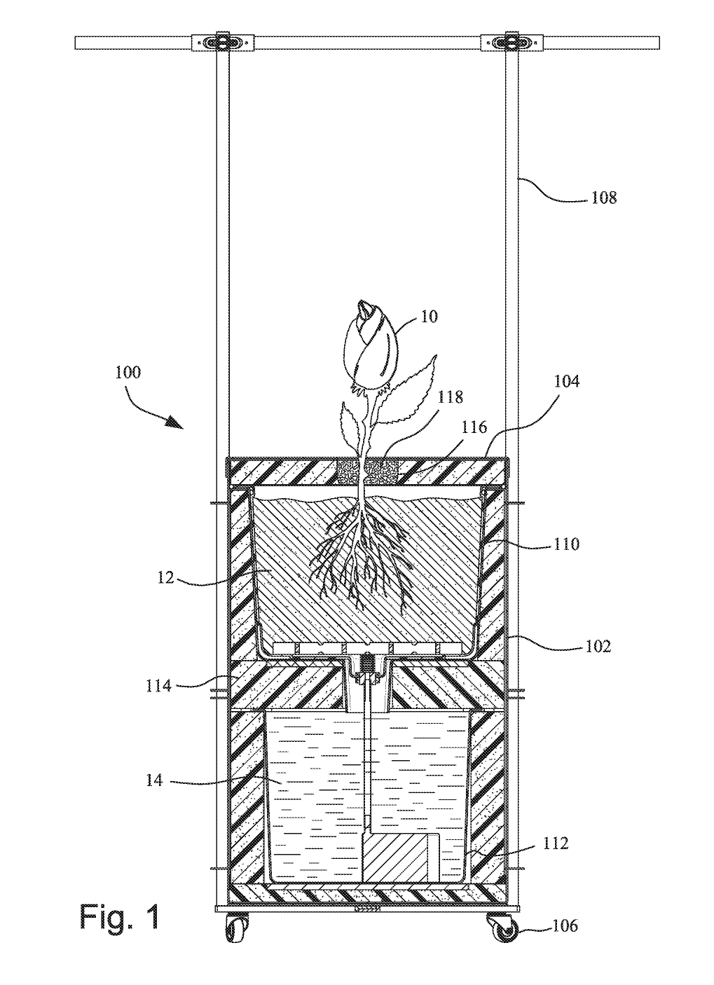

FIG. 1 illustrates an example of a device 100 for promoting root function of plant 10, where the device may be utilized in industrial farming. The device 100 may include an enclosure 102 with a lid 104, wheels or casters 106 and a trellis 108. The interior may include a first container 110 and a second container 112. Various interior volumes may be filled with insulation 114. The first container 110 may be suitable for a root growing medium 12, such as clay pellets, soil, sand, etc. The first container 110 may also be filled with a fluid instead of a solid medium. For example, the container may be substantially air-filed (along with suitable root support structure, if needed) if aeroponics is utilized or may be substantially liquid filled if hyrdoponics is utilized. The root growing medium may therefore also include any medium suitable for aeroponics or hydroponics. The second container 112 may be suitable for liquid 14, which may be water, water mixed with nutrients or any other liquid or liquid mixture suitable for delivery to the root growing medium 12. The lid 104 may include an opening or hole 116 that allows the plant 10 to protrude there through, and an air permeable medium 118 may be inserted into the hole 116 to surround a stalk of the plant 10 and provide a moisture and/or humidity barrier. Preferably, the permeable medium provides for air exchange while acting as a humidity barrier, while also being sufficiently soft to allow the plant 10 to grow without undue force being applied to the vegetation. An exemplary air permeable medium 118 is wool.

Preferably, the lid 104 is openable or removable to provide access to the interior of the device 100 through the top.

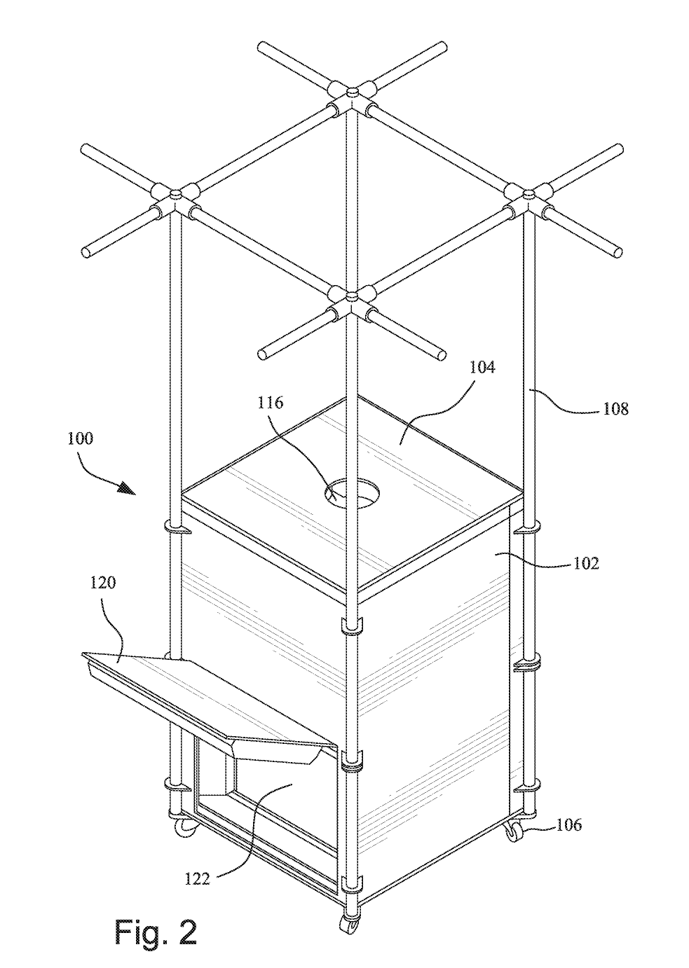

FIG. 2 illustrates a perspective view of the device 100, where the enclosure 102 is illustrated as a generally rectangular box with a substantially square horizontal cross-section. Any shape of the enclosure 102 may be utilized, although the disclosed configuration may achieve beneficial use of floor space by stacking internal components vertically.

The trellis 108 may be of any suitable configuration for supporting growth of the plant 10, but here is illustrated with a pole at each corner of the enclosure 102 and four horizontal poles at the top in a configuration of two pairs of parallel poles with the pairs being perpendicular to one another.

The enclosure 102 may include a door 120 that provides access to an opening 122. The door 120 may be a hinged panel, a removable panel, or any other type panel that covers the opening 122. The opening 122 may provide for access to and/or removal of the second container 112. This may allow for the second container to be refilled with or without removal, and/or may generally allow for access to the interior of the enclosure 102 and any contents therein.

A pump 124 may be included to deliver the liquid 14 from the second container 112 to the first container 110. The pump 124 may be in any convenient location, but here is illustrated within the second container 112 resting on the bottom interior surface. In this configuration, a fluid conduit 126 may extend upwards towards and be connected to the first container 110. A suitable valve 128 may open upon pressurization of the liquid 14 and allow the liquid 14 to flow into the first container 110 from the bottom upwards. The valve 128 may alternatively be a nozzle, sprinkler head, or similar device that does not open upon pressurization, which may allow the liquid 14 to drain from the first container 110 into the second container 112, backwards through the pump 124, when the pump 124 stops pumping. With this arrangement, liquid 14 filling from the bottom upwards will push out any air in the first container 110 and then draw in fresh air through the hole 116 as the level of the liquid 14 reduces. In an alternative, the pump 124 and/or the second container 112 may be outside of the enclosure 102, which may allow for multiple devices 100 to be services by a single second container 112 and/or pump 124.

Other plumbing arrangements may be utilized such that the liquid 14 enters the first container 110 in an appropriate manner. For example, the fluid could flow in from the top or an intermediate height of the container. The liquid 14 may also be delivered as a mist, which may be suitable for aeroponics. With the illustrated configuration, the fill level of the first container 110 may be controlled by an overflow opening or openings such as hole 130.

The first container 110 may be a double walled structure such that there is a space or gap 132 between an exterior and interior wall. A similar structure may be achieved by having two distinct containers where one is nested within the other. When the liquid 14 reaches the level of the hole 130, the liquid 14 may flow downwards through the gap 132 by way of gravity and return to the second container 112. A plurality of holes 130 are illustrated, although any number of holes 130, including a single hole, may be utilized. With this configuration, the first container 110 can be flooded in order to saturate the root growing medium 12 without overflowing the first container 110 if, for example, the first container includes an open top. One or more smaller holes, or otherwise flow-restricted flow paths, may be provided below the hole 130 so that any of the liquid 14 that is not absorbed by the root growing medium 12 may drain back into the second container 112 for future use. For example, a hole adjacent the valve 128 may be provided, where the hole is sufficiently small that the pump 124 can pump the liquid 14 into the first container 110 faster than the liquid 14 can flow out of the hole. The fluid level may continue to rise until it reaches the level of the hole 130. This may allow for circulation of the liquid 14 within the first container 110 to promote thorough and/or even distribution of the liquid 14.

The device 100 may include one or more heaters 134a, 134b. The heater 134a is preferably positioned such that generated heat is transferred to the liquid 14 within the second container 112. By heating the liquid 14, the root growing medium 12 and/or roots of the plant 10 may be heated, if desired, when the liquid 14 is transferred into the first container 110. The heater 134a may be positioned underneath the second container 112, as illustrated, to heat in this manner. This configuration may heat all of the interior of the device 100, in which case it may be preferable to omit the insulation 114 between the first container 110 and the second container 112.

The device 100 may include a second heater 134b that is positioned to heat the first container 110 and/or the root growing medium 12 within the first container 110. Although “second” is used to describe the second heater 134b, the second heater 134b may be the only heater within the device 100.

If a single heater is preferred, including a heater functionally equivalent to the heater 134a may be utilized because, for example, introducing the liquid 14 into the first container 110 may have undesirable results if the liquid 14 is not an appropriate temperature. If two heaters are included, the root growing medium 12 may be controlled at one temperature and the liquid 14 may be controlled at a second temperature. This may be advantageous if, for example, the plant 10 may benefit from receiving the liquid 14 at a different temperature than the temperature at which the root growing medium 12 and/or roots of the plant 10 are maintained.

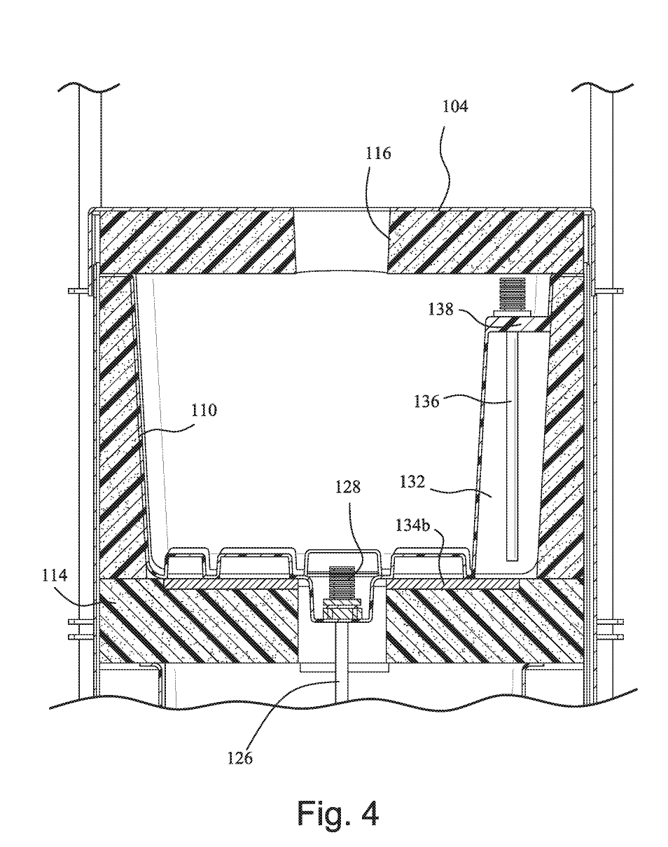

FIG. 4 illustrates an alternative cross-section focused on the portion of the device 100 including the first container 110. This figure differs in that a double walled construction is not illustrated, although a double walled structure could be employed. Also, a tube 136 connected to a horizontal portion 138 of the first container 110 provides for an overflow path of the liquid 14 within the gap 132, where the gap 132 is between the wall of the first container 110 and the insulation 114. The tube 136 may be utilized with the double walled construction detailed above. When the liquid 14 reaches the level of the horizontal portion 138, the liquid 14 may flow into the tube 136 and flow downwards. Although the tube 136 is illustrated as ending near the bottom of the first container 110, the tube 136 could extend further downwards, and could extend through the insulation 114 to allow flow directly into the second container 112.

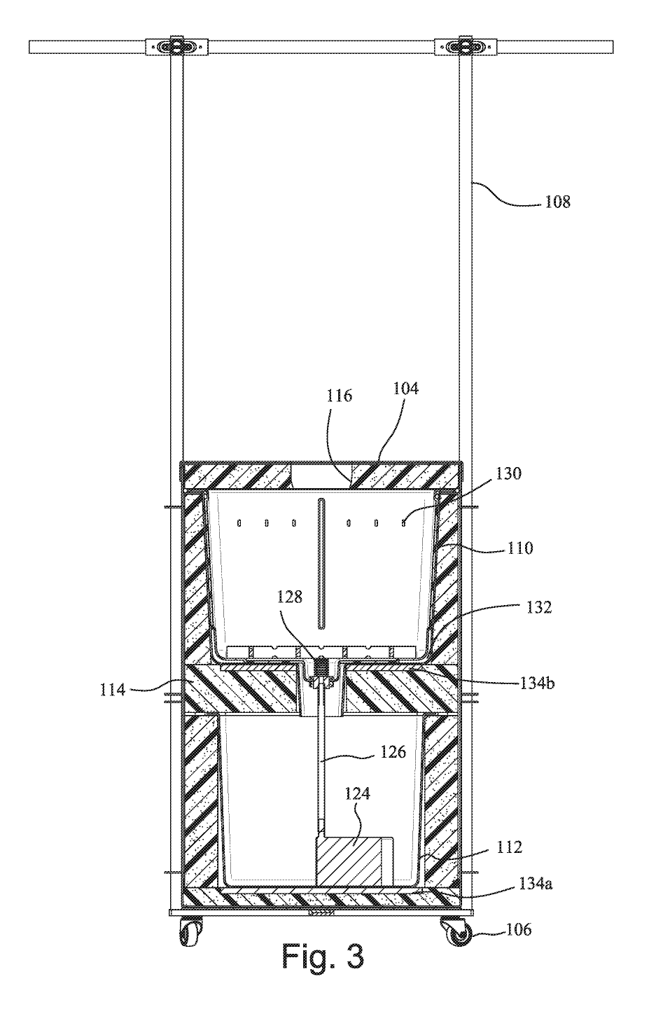

The tube 136 may be filled with quartz to allow the liquid 14 to flow over the quartz. The tube 136 may include one or more openings, such as a slit, the in the side of the tube to allow additional flow path exits for the liquid 14. Alternatively, or in addition, the quartz may be included in the gap 132 in the configurations of both FIGS. 3 and 4

Including quartz in a flow path of the liquid 14 may condition the liquid 14 in a beneficial manner. For example, the liquid 14 flowing over the quartz may generate ions within the liquid 14 that are beneficial for the plant 10. The quartz may be included in any flow path of the liquid 14.

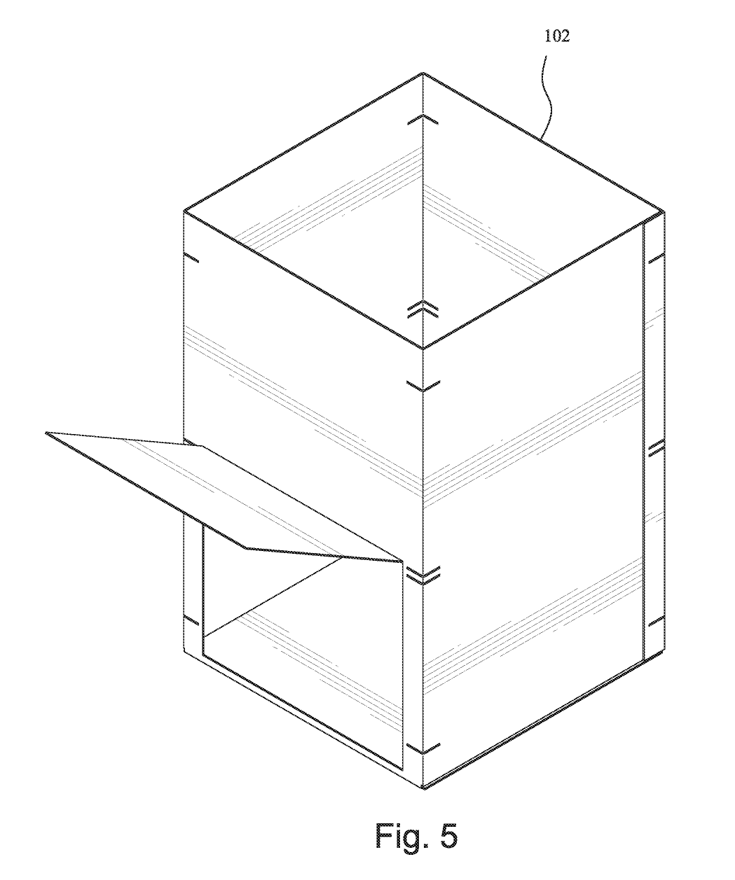

FIG. 5 illustrates the enclosure 102 in isolation. The enclosure 102 may be made from any suitable material. An exemplary material is corrugated plastic, which may be purchased in standard sizes such as four feet by eight feet.

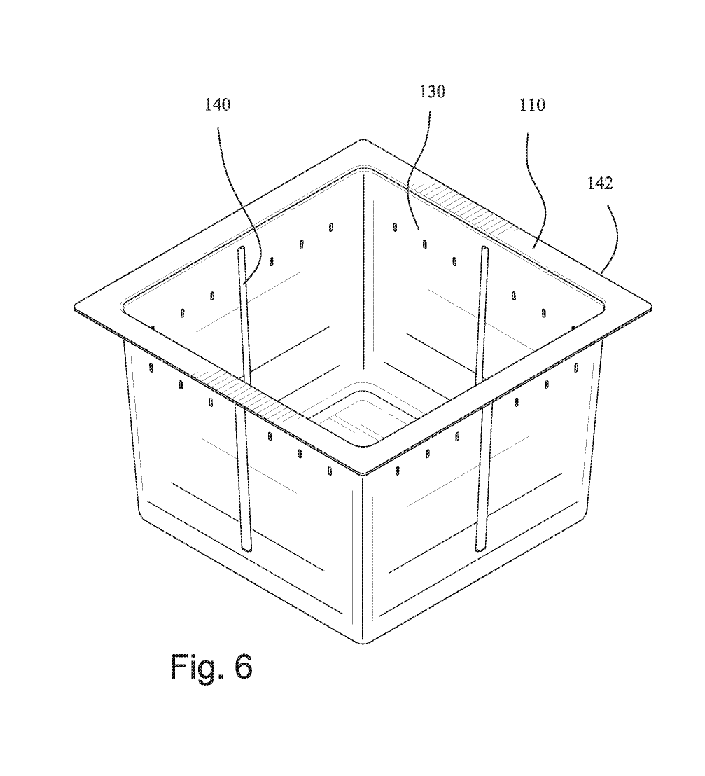

FIG. 6 illustrates an example of the first container 110, illustrated as a substantially rectangular prism with an open top. This figure illustrates a single wall configuration, which may be equivalent to an inner container as described above with respect to FIG. 2. A plurality of the holes 130 are illustrated all around the perimeter at a predetermined height. A stiffening rib 140 is included in a vertical orientation on each side of the first container 110. The stiffening rib 140 may help to maintain the thickness of the gap 132.

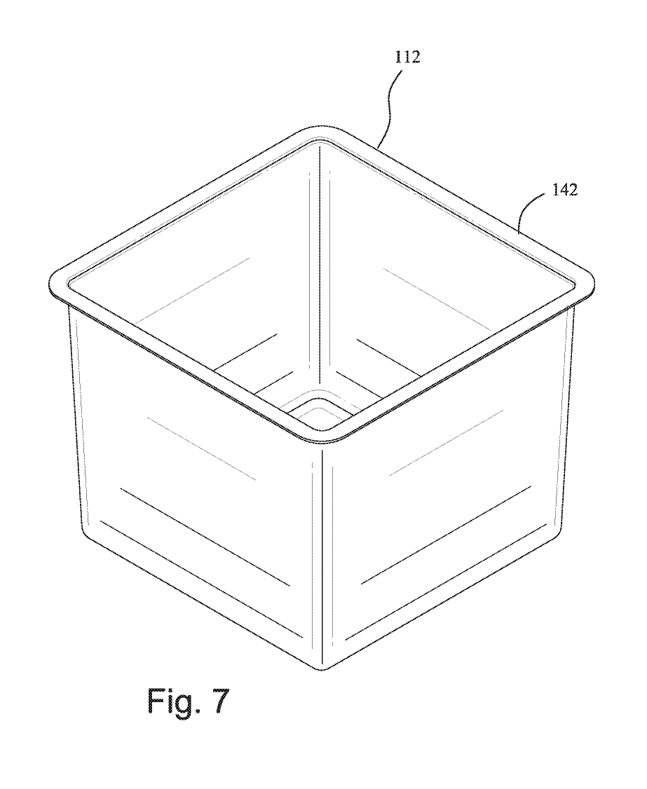

FIG. 7 illustrates an example of the second container 112, illustrated as a substantially rectangular prism with an open top.

The configuration illustrated in FIGS. 1-4 may be achieved with the first container 110 and the second container 112 on shelves that are fixed with respect to one another. This may be achieved by a separate shelves that support a bottom side of each respective container. This may also be achieved by a separate fixed angle brackets that allow the first container 110 and the second container 112 to be supported at their respective lips 142. However, in an alternative, the first container 110 may be held in a height adjustable manner. For example, a plurality of fixed angle brackets may allow the first container to be suspended by the lip 142 at the top of the first container 110. Alternatively, the first container 110 may be suspended by a cable system that may allow the first container 110 to be raised and lowered by a motor 210. Allowing for height adjustment of the first container 110 may allow for the position of the plant 10 to be adjusted within the hole 116.

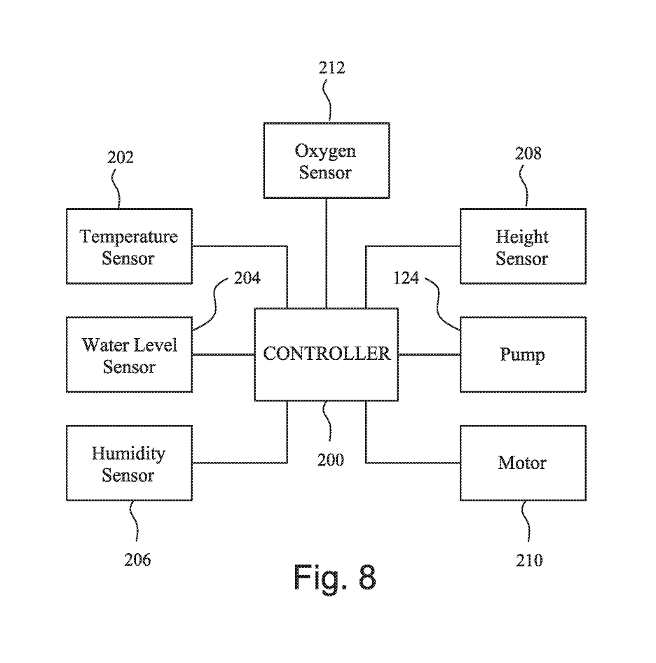

FIG. 8 illustrates a controller 200 and various components that interact with the controller 200 such as a temperature sensor 202, a water level sensor 204, a humidity sensor 206, a height sensor 208, the motor 210, an oxygen sensor 212 and the pump 124. The controller 200 may be a special purpose or general purpose computer or any other suitable control electronics. The controller 200 may be a distributed system. For example, one or more of the temperature sensor 202, the water level sensor 204, the humidity sensor 206, the height sensor 208, the motor 210 and the pump 124 may have internal controls that govern their operation and a separate device, such as a mobile phone, may have an application that provides user controls, data output and/or additional computational power. The controller 200 may have a wired or wireless connection between any of the various components.

The temperature sensor 202 can be a plurality of sensors if, for example, multiple locations can benefit from temperature measurement. For example, it may be beneficial to measure the temperature of the liquid 14 and/or the root growing medium 12.

Similarly, it may be beneficial to measure water level in more than one location, such as in the first container 110 and the second container 112, and thus the water level sensor 204 may be a plurality of sensor. The water level sensor 204 may have any suitable form. For example, a strain gauge may be used to measure strain in a support for a container or within a container itself, which may be correlated to weight, and thus height, of liquid 14. The water level sensor 204 may comprise a float coupled with a switch such that the switch is actuated by the float reaching a predetermined height. Any suitable method for sensing the height of a fluid may be utilized.

The humidity sensor 206 may also be a plurality of sensors. Including a humidity sensor 206 within the first container 110 may allow for humidity measurement of the root growing medium 12. A humidity sensor 206 configured to measure the ambient humidity of the device 100 may be beneficial. Such as external sensor may be useful to perform calculations to determine the needs of the plant 10. For example, if the exterior of the device 100 is very dry, the plant 10 may require more liquid 14 than in a condition where the exterior is relatively wet.

The height sensor 208 may be utilized to determine the height of the plant 10. The height sensor 208 could be in the form of an optical beam sensor that is triggered by a part of the plant 10 blocking the optical beam. If multiple height sensors 208 are included, multiple heights of the plant may be measured.

The oxygen sensor 212 may be a zirconia based sensor, a titania (titanium dioxide) based sensor, a mass spectrometer, or any suitable sensor for detection of oxygen. Preferably the oxygen sensor 212 is located to detect oxygen within the root growing medium 12.

With one or more of the control elements described, various control methodologies may be implemented. For example, a temperature sensor 202 may be placed to monitor temperature of the root growing medium 12 and/or root zone of the plant 10. If the temperature sensor detects a temperature that is less than a first predetermined temperature, the heater 134a or heater 134b, or both, is turned on. The temperature is monitored and if the temperature increases to a second predetermined temperature (e.g., a higher temperature than the first predetermined temperature), heating is stopped. If the temperature exceeds the second predetermined temperature for a predetermined time or reaches a third predetermined temperature (e.g., a higher temperature than the second predetermined temperature), an alert may be generated. The alert may be, for example, a message sent to a smart phone.

Using the water level sensor 204 the level of the liquid 14 can be determined, preferably within the second container 112, and if the water is below a predetermined level, an alert may be generated. If the water level sensor 204 detects the level of the liquid 14 to be above a predetermined level, an alert may be generated. Either or both of these alerts may be, for example, a message sent to a smart phone.

Using the humidity sensor 206, if the humidity within the first container 110 falls outside of a predetermined humidity range, an alert may be generated. The alert may be, for example, a message sent to a smart phone. The alert could indicated whether the humidity is above or below the predetermined range, or could simply indicate that the humidity is outside of the range.

The height sensor 208 may be used to control the motor 210. If, for example, the height of the plant 10 exceeds a predetermined distance above the lid 104, the motor 210 can lower the first container 110. The first container may be lowered a predetermined amount or lowered until the height sensor 208 can no longer detect the plant 10 (e.g., lowered a variable amount).

Using the oxygen sensor 212, oxygen delivery can be controlled. For example, oxygen concentration can be detected and controlled to be within a predetermined range. If the range is above normal atmospheric oxygen concentration, supplemental oxygen will be required. Supplemental oxygen may be from pressurized oxygen storage sources, e.g., high pressure gas or liquefied oxygen, or may be from oxygen concentration devices that generate oxygen in real time, such as pressure swing adsorption systems, ceramic oxygen concentrators or distillation columns.

At least one embodiment of the present technology may include one or more advantage. For example, the device 100 may maximize the amount of space available to use in a four foot by eight foot sheet of corrugated plastic. Corrugated plastic may provide desirable rigidity, ability to be cleaned, insulation properties and cost to manufacture.

With insulation sufficient maintain the interior at 65-75 degrees Fahrenheit for 18 hours while the vegetation area temps are 85-90 degrees Fahrenheit may allow the device 100 to act as a cooler during warm external temperatures, such as may be experienced in a greenhouse, so that the plants can uptake the CO₂ at a desirable rate, such as 2000 ppm, in the greenhouse and maximize plant production by keeping the root zone at a preferred temperature to digest nutrient solution.

The root zone may be isolated from the surrounding environment, such as a greenhouse, by encapsulation of the root zone with insulation. Packing the hole 116 with a wool collar may provide for insulation and filtration for air entering the device 100. The wool may also act to restrict the evaporation of water in the nutrient solution into the vegetation area. Evaporation may be undesirable if it wastes water and changes the composition of the fertilizer solution before absorption by the plant. If evaporation is prevented, the system may provide consistent nutrient solution at the correct temperature for each species of plant as well as ideal absorption by changing the temperature according to species.

A heating system may keep the root zone warm when the respiration or night cycle is present in the vegetation area. In some conditions, the temperature can go down as low as ten degrees Fahrenheit in the vegetation area. This may help the plant deal with predators when the vegetation areas are cooler at night than the root zone. This may provide a natural resistance to predators with minimal, if any, pesticides introduced in the vegetation.

Including casters 106 or similar mobility devices may allow for best positioning within a growing area, such as a greenhouse, according to the light needs of each stage of growth without having to move the lights. Moving lights may be relatively more difficult because of electrical wiring.

Including a heater for the liquid 14 may allow for temperature adjustment of the nutrient solution to a preferred temper for each species of plant in each stage of development from starting as a seedling or clone to maturity. The device 100 may allow for ice can be added, e.g., by way of the lid 104 or into the second container 112, to cool the root zone for ripening. During ripening, plants may not like high humidity in the vegetation area and separating the root zone from the vegetation may allow for the plants to ripen on an industrial scale without molding that may occur due to high humidity associated with an open system.

While the present technology has been described in connection with what is presently considered to be the most practical and preferred embodiments, it is to be understood that the present technology is not to be limited to the disclosed embodiments, but on the contrary, is intended to cover various modifications and equivalent arrangements included within the spirit and scope of the appended claims.

1. A device for promoting root function of a plant in industrial farming, the device comprising:
a first container configured to retain a root growing medium;
an insulated enclosure surrounding the first container and including an opening above the first container through which the plant may grow such that the device is configured to surround a root zone of the plant with insulation and separate the root zone from vegetation of the plant, wherein the opening is smaller than a maximum horizontal width of the first container;
a wool collar within the opening and sized to surround the plant at the opening;
a second container below the first container and within the insulated enclosure, wherein the second container is configured to store a liquid;
a pump and at least one conduit configured to transport the liquid from the second container to the first container;
a heater within the insulated enclosure; and
a flow path from the first container to the second container that allows the liquid to flow from the first container to the second container by way of gravity;
wherein the insulated enclosure has insulation configured to maintain the root growing medium between 65 and 75 degrees Fahrenheit while the exterior of the insulated enclosure is exposed to temperatures between 85 and 90 degrees Fahrenheit for 18 hours followed by exposure to 32 degrees Fahrenheit for 6 hours.

2. The device according to claim 1, wherein the flow path includes an opening at a predetermined height within the first container such that when the liquid in the first container reaches the predetermined height, the liquid begins to flow out of the first container and into the flow path.

3. The device according to claim 1, further comprising a quartz medium within the flow path configured to be contacted by the liquid flowing through the flow path.

4. The device according to claim 1, further comprising an insulation layer between the first container and the second container.

5. The device according to claim 4, wherein the insulation layer insulates the first container from the heater.

6. The device according to claim 1, wherein the heater is below the second container and positioned to heat the liquid within the second container.

7. The device according to claim 1, wherein the at least one conduit is connected to the first container so that the liquid enters the first container at a bottom surface of the first container.

8. The device according to claim 1, wherein the insulated enclosure includes a door that is configured to open to allow removal of the second container.

9. The device according to claim 1, further comprising a third container in which the first container is nested to form a gap between the outside of the first container and the inside of the third container, and the flow path comprises the gap.

10. The device according to claim 9, wherein the first container comprises a least one drip hole that provides fluid communication into the gap.

11. A device for promoting root function of a plant, the device comprising:
a first container configured to retain a root growing medium;
a second container below the first container, wherein the second container is configured to store a liquid;
an insulated enclosure surrounding the first container and the second container and including an opening above the first container that is sized so that the plant may grow through the opening;
a pump configured to transport the liquid from the second container to the first container;
a heater within the insulated enclosure; and
a flow path from the first container to the second container that allows the liquid to flow from the first container to the second container after the liquid is transported to the first container.

12. The device according to claim 11, further comprising quartz within the flow path, the quartz being configured to contact the liquid flowing through the flow path.

13. The device according to claim 11, further comprising an air permeable material configured to fit within the opening, to provide space for the plant within the opening at the same time as the air permeable material, and to inhibit moisture transport from inside to outside of the insulated enclosure.

14. The device according to claim 11, further comprising an insulation layer between the first container and the second container.

15. The device according to claim 14, wherein the insulation layer insulates the first container from the heater.

16. The device according to claim 11, wherein the heater is below the second container and positioned to heat the second container.

17. The device according to claim 11, wherein the pump is in fluid communication with the second container so that the liquid is pumped into the first container at a lowest point of the interior of the first container.

18. The device according to claim 11, further comprising a third container in which the first container is nested to form a gap between the outside of the first container and the inside of the third container, and the flow path comprises the gap.

19. The device according to claim 18, wherein the first container comprises at least one drip hole that provides fluid communication into the gap.

20. A device for promoting root function of a plant, the device comprising:
a container configured to retain a root growing medium;
an insulated enclosure surrounding the container and including an opening above the container that is sized so that a portion of the plant above the roots of the plant may be within the opening while the plant grows; and
a heater within the insulated enclosure.
